(19) United States
(12) Patent Application Publication
(10) Pub. No.: US 2016/0279918 A1
(43) Pub. Date: Sep. 29, 2016

(54) PLASTERBOARD JOINTING SYSTEM AND JOINTING COMPOUND

(71) Applicant: USG BORAL BUILDING PRODUCTS PTY LIMITED, Port Melbourne Victoria (AU)

(72) Inventor: Florabel DIONISIO, Taylors Hill (AU)

(73) Assignee: USG Boral Building Products Pty Limited, Port Melbourne, Victoria (AU)

(21) Appl. No.: 15/032,747

(22) PCT Filed: Oct. 24, 2014
(86) PCT No.: PCT/AU2014/050306

§ 371 Date: Apr. 28, 2016

(30) Foreign Application Priority Data
Nov. 1, 2013 (AU) 2013904235

(51) Int. Cl. B32B 37/12; C09J 129/04; C09J 7/02; E04F 13/04; B32B 37/14

(52) U.S. Cl. CPC B32B 37/12; E04F 13/042; B32B 37/142; C09J 7/02; C09J 129/04; B32B 2315/18; B32B 2405/00

(57) ABSTRACT

A two-coat plasterboard jointing system comprising a tape applied over a joint formed between plasterboard panels, a first coat of jointing compound applied to the joint between said plasterboard panels, and a second coat of finishing compound applied over said first coat, wherein the jointing compound includes a plaster component and a polymer component.

### FIELD OF THE INVENTION

The Invention relates to a jointing compound, a two-coat plasterboard jointing system and more particularly, but not exclusively, to a two-coat plasterboard jointing system providing a joint strength sufficient to be used as an alternative to existing three-coat plasterboard jointing systems.

### BACKGROUND OF THE INVENTION

Generally, in construction of walls of buildings it is common to fix plasterboard panels to form an interior wall surface, and to use a jointing system to provide a smooth and undetectable transition between the plasterboard panels. The jointing and finishing of plasterboard is typically carried out according to the required level of finish for domestic construction which requires that all joints and internal angles be taped and coated by firstly bedding jointing tape into an initial coat of jointing compound, subsequently applying a second coat of jointing compound, and finally applying a finishing top coat.

However, the applicant has identified that such existing three-coat jointing systems are time consuming and involve a relatively high labour cost, particularly owing to the need to wait for all three coats to dry, in turn. Typically, it may be necessary to wait at least one hour for the first coat to dry, four hours for the second coat to dry and 24 hours to allow the finishing coat to dry.

Examples of the invention seek to provide an improved plasterboard jointing system which overcomes or at least alleviates disadvantages associated with existing plasterboard jointing systems. In particular, examples of the present invention seek to provide a two-coat jointing system that delivers comparable joint strength and overall performance to existing conventional three-coat jointing systems using paper tape.

### SUMMARY OF THE INVENTION

In accordance with one aspect of the present invention, there is provided a two-coat plasterboard jointing system comprising a tape applied over as joint formed between plasterboard panels, a first coat of jointing compound applied to the joint between said plasterboard panels, and a second coat of finishing compound applied over said first coat, wherein the jointing compound includes a plaster component and a polymer component.

Preferably, the jointing compound is plaster based.

in a preferred form, the jointing compound includes fibres within the jointing compound. More preferably, the fibres are polymer-based fibres, Even more preferably, the jointing compound includes polymer-based fibres in a proportion less than 1% by weight.

Preferably, said first and second coats are applied over the tape. More preferably, the tape is self-adhesive tape.

Preferably, the tape is mesh tape. More preferably, the tape is fibreglass mesh tape.

In one form, the tape may be paper tape.

Preferably, the jointing compound contains at least 80% plaster by weight More preferably, the jointing compound contains approximately 80-95% plaster by weight. Even more preferably, the jointing compound contains 80-95% calcium sulphate hemihydrate (plaster of Paris) by weight.

Preferably, the polymer component is in the form of a polymer binder in a proportion of less than 5% by weight. More preferably, the polymer component is in the form of a polymer binder in a proportion of 2 to 5% by weight,

In accordance with another aspect of the present invention, there is provided a method of jointing two plasterboard panels, including the steps of fixing one plasterboard panel, relative to a second plasterboard panel such that an edge of the first panel faces an edge of the second panel to form a joint, applying tape over the joint, applying to the joint over the tape a first coat of jointing compound the jointing compound including a plaster component and a polymer component. and applying to the joint over the first coat a second coat of finishing compound.

More preferably, the tape is self-adhesive tape.

In a preferred form, the jointing compound includes fibres within the jointing compound. More preferably, the fibres are polymer-based fibres.

Preferably, a majority component of the jointing compound is plaster. More preferably, the jointing compound includes a polymer component.

In accordance with another aspect of the present invention, there is provided a two-coat plasterboard jointing system comprising a first coat of jointing compound applied to a joint formed between plasterboard panels, and a second coat of finishing compound applied over said first coat, wherein the jointing compound includes a piaster component and a polymer component.

Preferably, the jointing compound contains at least 80% plaster. More preferably, the jointing compound contains approximately 80-95% plaster. Even more preferably, the jointing compound contains 80-95% calcium sulphate hemihydrate (plaster of Paris).

Preferably, the polymer component is in the form of a polymer binder in a proportion of less than 5% by weight. More preferably, the polymer component is in the form of a polymer binder in a proportion of 2 to 5% by weight.

Preferably, the jointing compound includes fibres within the jointing compound. More preferably, the fibres are polymer-based fibres. Even more preferably, the jointing compound includes polymer-based fibres in a proportion less than 1% by weight.

In accordance with another aspect of the present invention, there, is provided a method of jointing two plasterboard panels, including the steps of fixing one plasterboard panel relative, to a second plasterboard panel such that an edge of the first panel faces an edge of the second panel to form a joint, applying to the joint a first coat of jointing compound, the jointing compound including a plaster component and a polymer component, and applying, to the joint over the first coat a second coat of finishing. compound.

In accordance with yet another aspect of the present invention, there is provided a plasterboard jointing compound including a plaster component and a polymer component. wherein the plaster component is in the form of calcium sulphate hemihydrate (plaster of Paris) at a proportion of greater than 80% by weight

Preferably, the polymer component is in the form of a polymer binder m a proportion of less than 5% by weight. More preferably, the polymer component is in the form of a polymer binder in a proportion of 2 to 5% by weight.

Preferably, the jointing compound includes fibres within the jointing compound. More preferably, the fibres are polymer-based fibres. Even more preferably, the jointing compound includes polymer-based fibres in a proportion of less than 1% by weight.

Preferably, the jointing compound includes the following components in the listed proportions by weight:

| | |
|---|---|
| Calcium Sulphate Hemihydrate | 80-95% |
| Mica | <7.5% |
| Talc | <7.5% |
| Polymer binder | 2-5% |
| Attapulgite Clay | <1% |
| Cellulose thickener | <0.5%. |

In one form, the jointing compound also includes the following component in the listed proportion by weight:

| | |
|---|---|
| Polymer fibre | <1%. |

### BRIEF DESCRIPTION OF THE DRAWINGS

The invention is described, by way of non-limiting example only, with reference to the accompanying drawings, in which:

FIG. 1a shows a graph of joint strength test results;

FIG. 1b shows a corresponding table of load and displacement test results;

FIG. 2a shows a graph of joint strength test results for two different plasterboard thicknesses;

FIG. 2b shows a table of load and displacement test results corresponding to FIG. 2a;

FIG. 3a shows a graph of join(strength test results including a two-coat joint system using a conventional jointing compound;

FIG. 3b shows a table of load and displacement test results corresponding, to FIG. 3a; and

FIG. 4 shows a table listing components of a conventional jointing compound and two high-strength jointing compounds.

### DETAILED DESCRIPTION

In existing conventional three-coat plasterboard jointing systems, a first coat of a plaster-based jointing compound is used to fill a recessed joint, using a flexible 75 min or 100 mm broad knife. Subsequently, paper tape is centred and pressed into the jointing compound using a 150 mm broad knife (or other mechanical tool), drawing along the joint with sufficient pressure to remove excess compound. Bubbles are expelled, taking care to ensure that sufficient jointing compound is left under the tape to provide a strong bond. After embedding the tape, a skim coat of the jointing compound is applied over the tape. Typically, the paper tape may be in the form of high strength cross -fibre slotted paper tape possessing exceptional wet strength. The paper tape resists stretching, crinkling and tearing.

Prior to applying a second coat, the first coat is allowed to set for at least one hour or longer. depending on the type of jointing compound, Subsequently, a second coat of jointing compound approximately 200 mm in width is applied over the joint using a trowel or broad knife, using the same jointing compound as was used in the first coat.

The second coat is allowed to dry for at least four hours, prior to applying a finishing coat. Once the first and second base coats have set, the joint is scraped to remove any rough spots or lumps. A finishing compound is then applied as a third coat, using a trowel to apply the coat with a width of approximately 250 mm, feathering out to at least 50 mm beyond edges of the base coat. A curved trowel on the finishing coat may be used to produce a slight convex curve. A damp sponge may be used to wipe down edges of joints and corners to reduce the need for sanding. The finishing coat is allowed to dry for a minimum of 24 hours, possibly longer in cold and/or wet weather conditions. When dry, the finishing coat is lightly sanded to a smooth finish with sand paper. The finishing compound may be in the form of a vinyl-based premixed product.

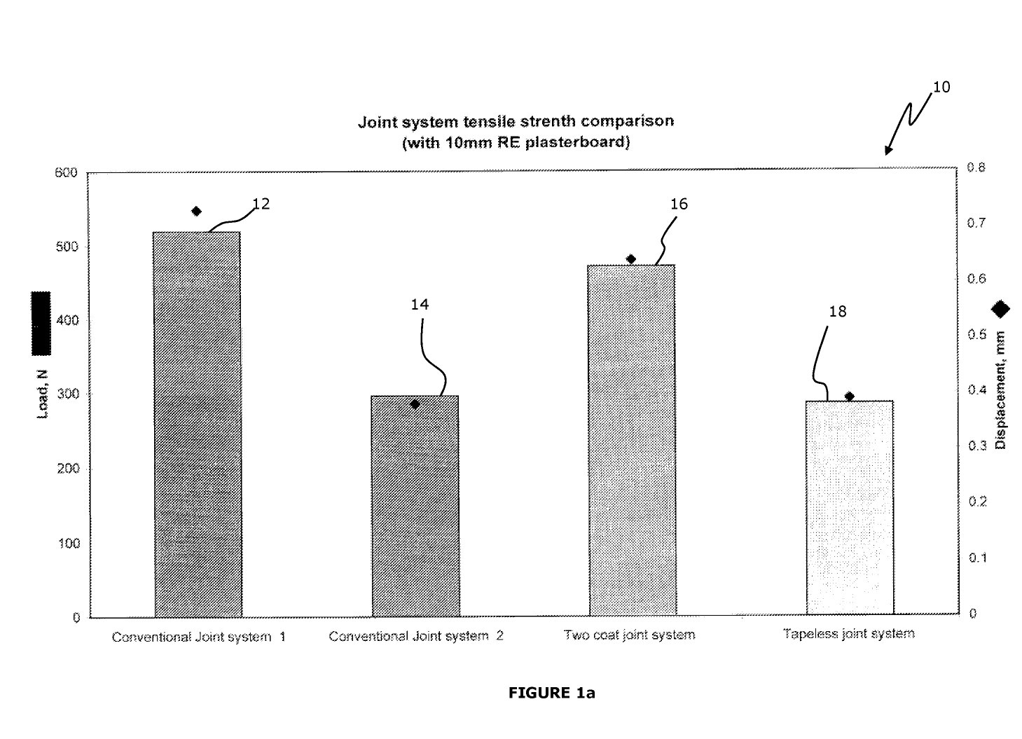

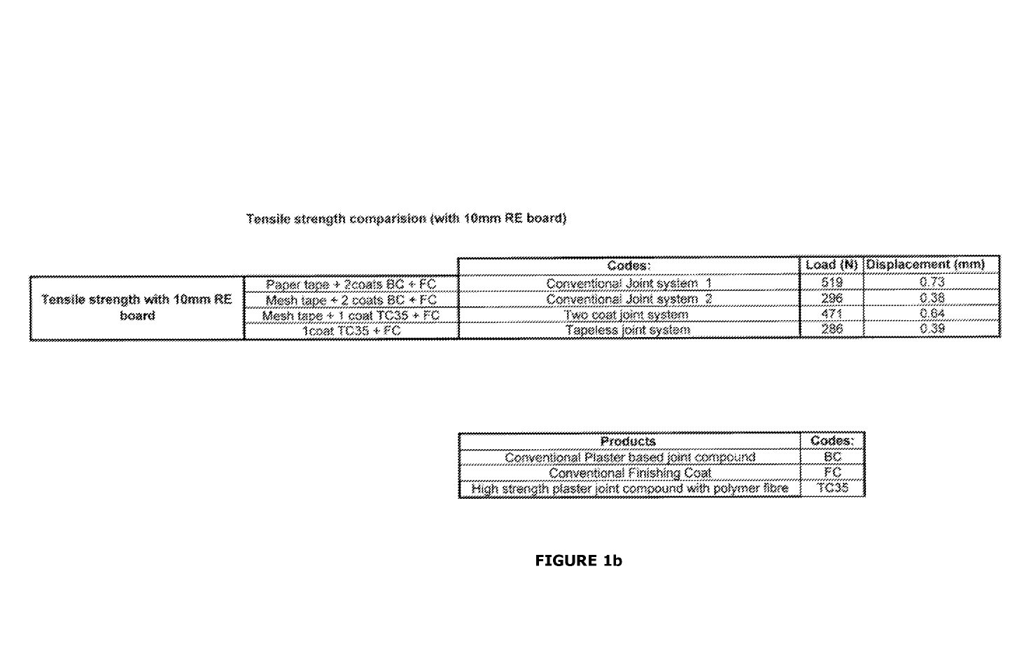

With reference to FIGS. 1a and 1b. results are shown for the tensile joint strength provided by such an existing conventional three-coat jointing system. More specifically, with reference to FIG. 1a, there is shown a bar chart 10 having a first bar 12 and a second bar 14, both of which represent the load achieved in testing joint strength of conventional three-coat jointing systems. More specifically, first bar 12 represents a load of 519 Newtons achieved using the applicant's conventional recommended joint system which comprises the applicant's conventional three-coat jointing system using paper tape. The second bar 14 shows a load of 296 Newtons achieved using a three-coat jointing system with a mesh tape. Although the load achieved using the mesh tape is significantly lower than the load achieved using paper tape, the system using mesh tape is still considered to be acceptable.

Accordingly, the applicant has sought to develop a two-coat jointing system using tape which achieves similar load and displacement to the conventional system represented by the first bar 12, as well as a tapeless two-coat jointing system which achieves, similar load and displacement results to the existing three-coat jointing system represented by the second bar 14.

The vertical axis on the right hand side of the bar chart 10 represents displacement, showing that the first bar 12 represents a joint displacement of 0.73 mm, whereas the second bar 14 achieves a joint displacement of 0.38 mm, With reference to FIG. 1b of the drawings, the first bar 12 corresponds to the first row of the table in FIG. 1b, and the second bar 14 of FIG. 1a corresponds to the second row of the table in FIG. 1b.

As such, the applicant sought to develop a two-coat jointing system which would reduce application time and labour cost. In particular, the applicant sought to achieve a first stage objective of developing a two-coat jointing system with mesh tape which can achieve similar load and displacement results to the existing jointing system represented by the first bar 12, and a second stage objective of developing a tapeless two coat jointing system which achieves load and displacement results sufficient for use as an alternative to the existing three-coat jointing system represented by the second bar 14. Advantageously, the applicant, has developed the present invention, examples of which provide two-coat jointing systems which do not sacrifice strength when compared to existing three-coat jointing systems.

The applicant has developed a two-coat plasterboard jointing system comprising a first coat of jointing compound applied to a joint formed between plasterboard panels, and a second coat of finishing compound applied over the first coat. The jointing compound used for the first coat includes a plaster component and a polymer component.

In one particular form, the jointing compound may be polymer based and may include fibres within the jointing compound. The fibres may be polymer-based fibres which add strength to the jointing compound when the jointing compound is set so as to compensate for the omission of the third coat of conventional jointing systems and also the possible omission of a tape. Where the jointing system is to include the application of tape over the joint, the tape may be in the form of a self-adhesive tape, and the self-adhesive tape may be in the form of fibreglass mesh tape. In an alternative, the tape may be in the form of a paper tape, however it is considered that mesh tape is preferred.

The jointing compound may comprise a majority component of plaster. preferably with at least 80% of the jointing compound by weight being plaster. Even more preferably, approximately 80-95% of the jointing compound by weight is plaster. This compares with a plaster component of approximately 60% used in existing jointing compounds of coiiventional three-coat jointing systems. The applicant has found it is necessary for the proportion of plaster to be within the range of 80-95% by weight to balance strength, workability, and brittleness.

Accordingly, in using the process according to the present invention, there is provided a method of jointing two plasterboard panels, including the steps of fixing one plasterboard panel relative to a second plasterboard panel such that an edge of the first panel faces an edge of the second panel to form a joint applying to the joint a first coat of the jointing compound, the jointing compound including a plaster component and a polymer component, and applying to the joint a second coat of finishing compound. In this way a tapeless two-coat jointing system may be achieved. Optionally, the method may thither include a step of applying tape over the joint, prior to the step of applying the first and second coats. In this way, a two-coat jointing system using tape may be achieved.

A third bar 16 of the bar chart 10 in FIG. 1a represents test figures for load and displacement of a two-coat jointing system in accordance with an example of the present invention using a meshed tape, a jointing compound developed by the applicant entitled “TC35”, and a finishing compound in the form of a premixed, vinyl-based finishing compound. As can be seen, the test result represented by the third bar 16 achieves a load of 471 Newtons and a displacement of 0.64 mm, corresponding to row 2 of the table in FIG. 1b. The test data is taken at the initial visible crack. Load is the force applied on the joint during a tensile strength test, and displacement is the extension of the joint when pulled during the tensile strength test. It is sought to achieve a tough joint, being a good combination of strength (high load) and ductility (high displacement).

The bar chart 10 of FIG. 1a also has a fourth bar 18 which shows a test result for the tapeless two-coat jointing system, comprising the jointing compound TC35 and the vinyl-based finishing compound. As can be seen, the test result represented by the fourth bar 18 achieves load and displacement results similar to those represented by the second bar 14.

Advantageously, the applicant has developed a two-coat jointing system which is capable of reducing application time and labour cost of jointing plasterboard panels. in particular, tests have demonstrated that the two-coat jointing system using mesh tape may achieve results comparable to conventional three coat jointing systems using paper tape, and that a tapeless two-coat jointing system may achieve joint strength results comparable to a conventional acceptable mesh tape three-coat jointing system.

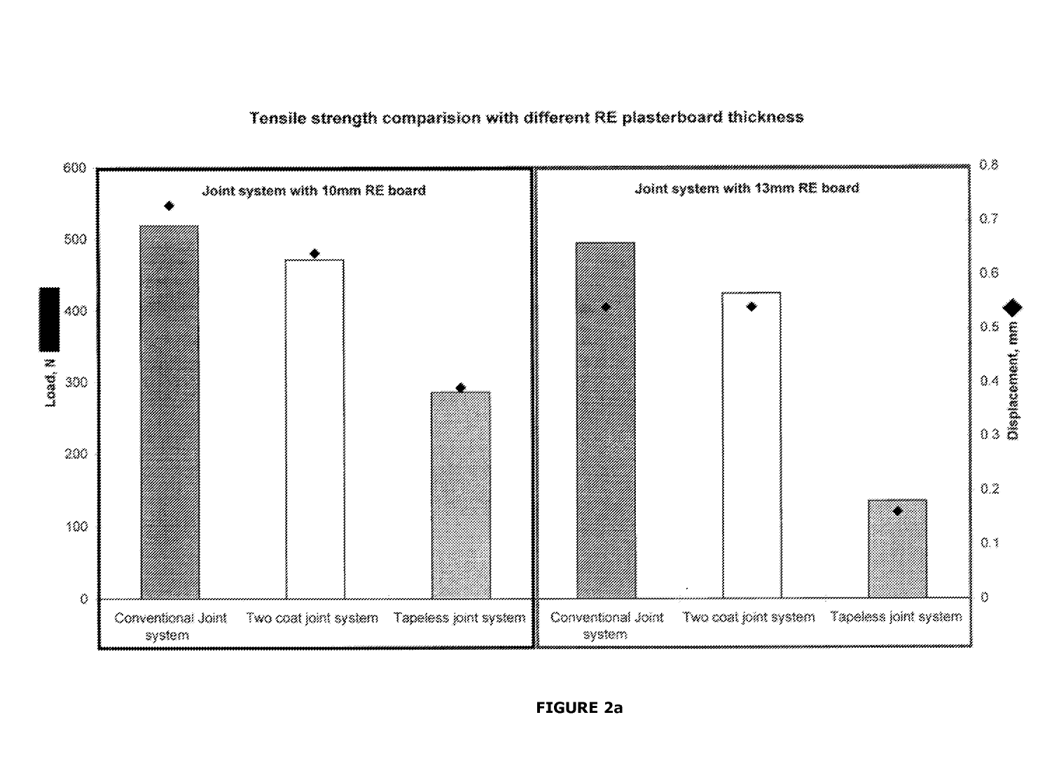

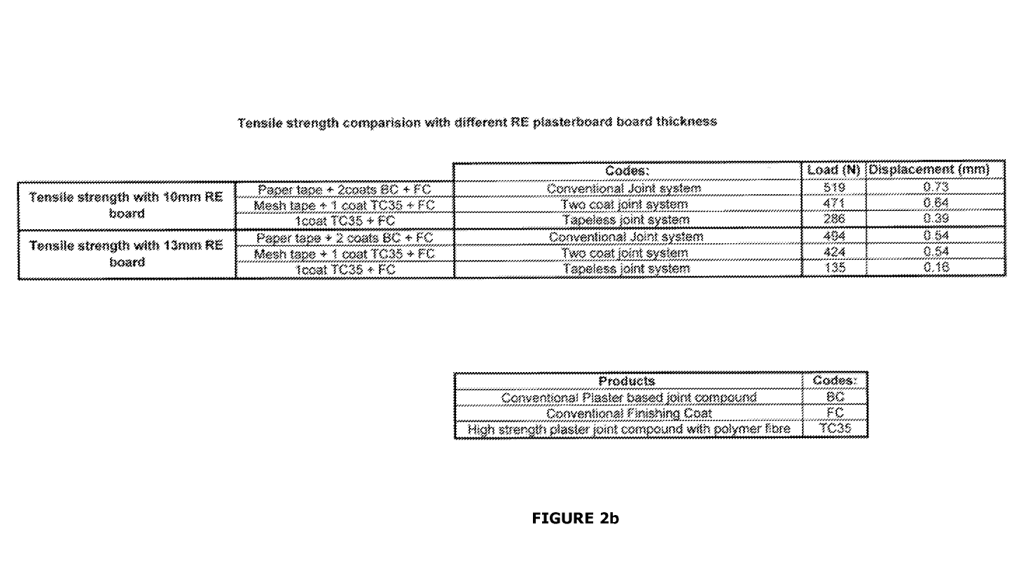

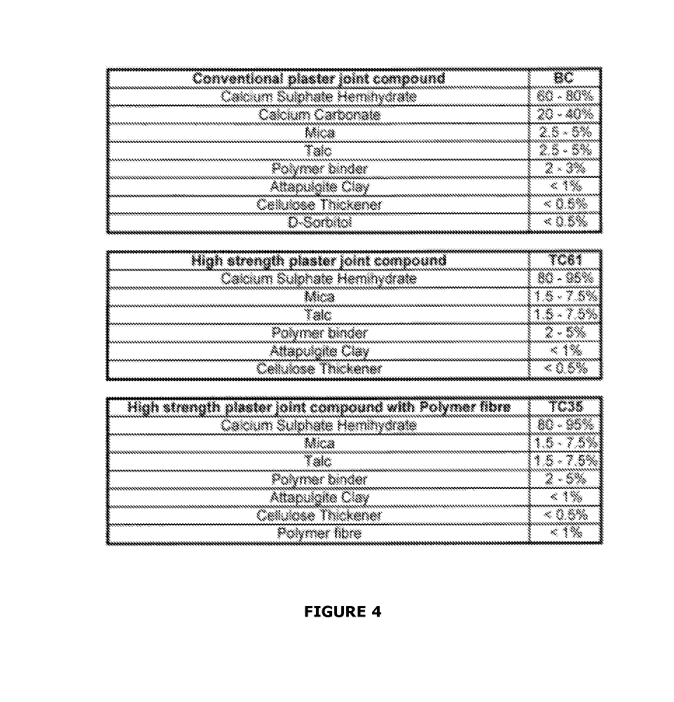

With reference to FIGS. 2a and 2h, there are shown a graph and corresponding data table for (i) a conventional three-coat joint system, (ii) a two-coat joint system and (iii) a tapeless two-coat joint system using two different plasterboard thicknesses (10 mm and 13 mm). As can be seen, the tapeless two-coat joint system in particular provides more comparable results when used with 10 mm board rather than 13 mm board. The table of FIG. 2b shows that both of the two-coat systems tested (with and without tape) use the TC35 jointing compound, component details of which are shown in FIG. 4.

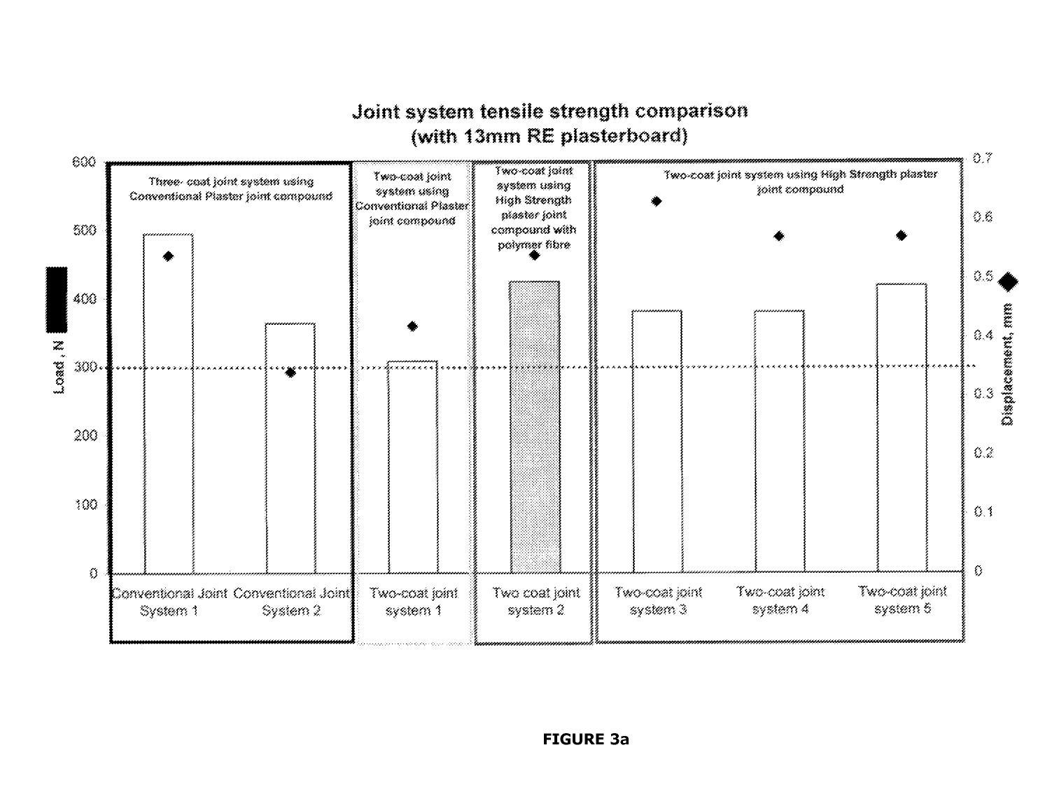

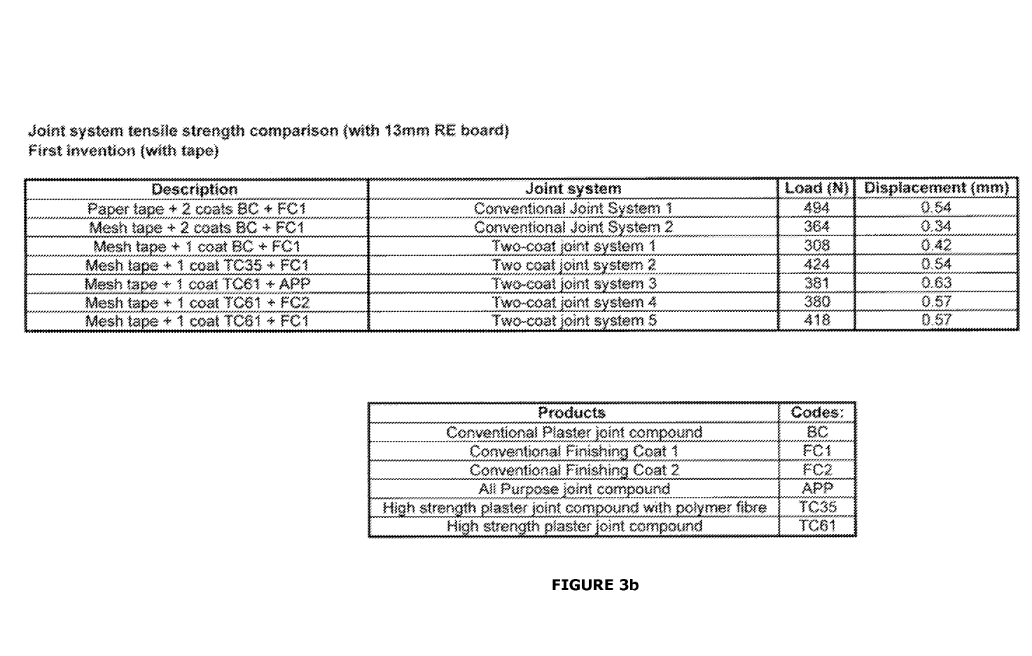

Turning to FIGS. 3a and 3b, there are shown a graph and corresponding data table for two conventional joint systems, and five two-coat joint systems, details of which are provided in the table of FIG. 3b. As can be seen, all of the two-coat joint systems tested here include mesh tape, and use either TC35 or TC61 as listed in the table. The components of TC35 and TC61 can be seen in FIGS. 4, compared with the components of a conventional jointing compound. TC35 and TC61 have the same components, with the exception that TC35 includes fibres whereas TC61 does not. The fibres of TC35 may be particularly beneficial in a tapeless joint, system, as the fibres serve to hold together the set compound in the absence of the tape.

However, it may be desirable not to have fibres in the jointing compound, in which case TC61 may be preferred. As can be seen in FIGS. 3a and 3b, two-coat system 2 and two-coat system 5 work particularly well, with strength results relatively close to that of the conventional joint system using paper tape (conventional joint system 1). Advantageously, the two-coat systems using TC35 or TC61 developed by the applicant are much stronger in tests than a two-coat system using a conventional jointing compound (compare with two-coat joint system 1). Accordingly, it is demonstrated that the compounds TC35 and TC61 detailed in FIG. 4 are particularly well-suited to use in two-coat joint systems for plasterboard.

More specifically, the compounds TC35 and TC61 are well-suited to use in two-coat jointing systems for plasterboard because they have a higher percentage component of Calcium Sulphate Hemihydrate, as shown in FIG. 4. The applicant determined that for additional strength it would be beneficial for the component of Calcium. Sulphate Hemihydrate, to be higher, and also identified that capacity to increase the proportion of this component could be accommodated by lessening or removing the component. of Calcium Carbonate which is an inert filler in conventional plaster joint compound. The applicant also determined that for additional strength, the proportional component of polymer binder may be increased from the range of 2-3% to the range of 2-5%. It was also determined that the proportional amounts of Mica and Tale should remain generally in the same order (although the percentage range for each could be broadened to 1.5-7.5%) as these components do not react and are needed to maintain consistency of the compound and, in particular, the workability of the compound to be similar to that of conventional plaster joint compound. The Talc component serves to maintain slippiness of the compound.

The polymer binder may be in the form of Polyvinyl Alcohol (PVA) with low molecular weight (27,000-32,000) to prevent the compound from being excessively brittle. Polyvinyl Alcohol (PVA) is an environmentally friendly and water soluble synthetic polymer with excellent film forming property, and emulsifying properties and outstanding resistance to oil, grease, and solvent, PVA is manufactured by polymerization of vinyl acetate monomer, followed by hydrolysis of the polyvinyl acetate. In particular, partially hydrolysed PVA with a degree of polymerization of 550-650 and molecular weight of 27,000-32,000 may be used. Note that other higher molecular weight: PVA and other VAE (vinyl, acetate-ethylene) binders have been trialled. They also gave excellent joint strength but had a reduced application performance in that it may be difficult to apply in practice. The applicant considers this may be due to the high molecular weight PVA tending to absorb water. To improve the workability, more water may be required and this will possibly reduce the joint strength.

While various embodiments of the present invention have been described above, it should be understood that they have been presented by way of example only, and not by way of limitation. It will be apparent to a person skilled in the relevant, art that various changes in form and detail can be made therein without departing from the spirit and scope of the invention. Thus, the present invention should not he limited by any of the above described exemplary embodiments.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Throughout this specification and the claims which follow, unless the context requires otherwise, the word “comprise”, and variations such as “comprises” and “comprising”, will he understood to imply the inclusion of a stated integer or step or group of integers or steps but not the exclusion of any other integer or step or group of integers or steps.

1. A two-coat plasterboard jointing system comprising a tape applied over a joint formed between plasterboard panels, a first coat of jointing compound applied to the joint between said plasterboard panels, and a second coat of finishing compound applied over said first coat, wherein the jointing compound includes a plaster component and a polymer component.

2. A two-coat plasterboard jointing system as claimed in claim 1, wherein the jointing compound is plaster based.

3. A two-coat plasterboard jointing system as claimed in claim 1 or claim 2, wherein the jointing compound includes fibres within the jointing compound.

4. A two-coat plasterboard jointing system as claimed in claim 3, wherein the fibres are polymer-based fibres.

5. A two-coat plasterboard jointing system as claimed in claim 4, wherein the jointing compound includes polymer-based fibres in a proportion less than 1% by weight.

6. A two-coat plasterboard jointing system as claimed in claim 1, wherein said first and second coats are applied over the tape.

7. A two-coat plasterboard jointing system as claimed in claim 6, wherein the tape is self-adhesive tape.

8. A two-coat plasterboard jointing, system as claimed in claim 1, wherein the tape is mesh tape.

9. A two-coat plasterboard jointing system as claimed in claim 8, wherein the tape is fibreglass mesh tape.

10. A two-coat plasterboard jointing system as claimed in claim 1, wherein the tape is paper tape.

11. A two-coat plasterboard jointing system as claimed in claim 1, wherein the jointing compound contains at least 80% plaster by weight.

12. A two-coat plasterboard jointing system as claimed in claim 11, wherein the jointing compound contains approximately 80-95% plaster by weight.

13. A two-coat plasterboard jointing system as claimed in claim 12, wherein the jointing compound contains 80-95% calcium sulphate hemihydrate (plaster of Paris) by weight.

14. A two-coat plasterboard jointing system as claimed in claim 1, wherein the, polymer component is in the form of a polymer binder in a proportion of less than 5% by weight, and more preferably between 2 and 5%.

15. A method of jointing two plasterboard panels, including the steps of fixing one plasterboard panel relative to a second plasterboard panel such that an edge of the first panel faces an edge of the second panel to form a joint, applying tape over the joint, applying to the joint over the tape a first coat of jointing compound, the jointing compound including a plaster component and a polymer component, and applying to the joint over the first coat a second coat of finishing compound.

16. A method of jointing two plasterboard panels as claimed in claim 15, wherein the tape is self-adhesive tape.

17. A method of jointing two plasterboard panels as claimed in claim 15, wherein the jointing compound includes fibres within the jointing compound.

18. A method of jointing two plasterboard panels as claimed in claim 17, wherein the fibres are polymer-based fibres.

19. A method of jointing two plasterboard panels as claimed in claim 15, wherein a majority component of the jointing compound is plaster.

20. A method of jointing two plasterboard panels as claimed in claim 15, wherein the jointing compound includes a polymer component.

21. A two-coat plasterboard jointing system comprising a first coat of jointing compound applied to a joint formed between plasterboard panels, and a second coat of finishing compound applied over said first coat, wherein the jointing compound includes a plaster component and a polymer component.

22. A two-coat plasterboard jointing system as claimed in claim 21, wherein the jointing compound contains at least 80% plaster.

23. A two-coat plasterboard jointing system as claimed in claim 22, wherein the jointing compound contains 80-95% plaster by weight.

74. A two-coat plasterboard jointing system as claimed in claim 23, wherein the jointing compound contains 80-95% calcium sulphate hemihydrate (plaster of Paris) by weight.

25. A two-coat plasterboard jointing system as claimed in claim 21, wherein the polymer component is in the form of a polymer binder in a proportion of less than 5% by weight, and more preferably between 2 and 5%.

26. A two-coat plasterboard jointing system as claimed in claim 21, wherein the jointing compound includes fibres within the jointing compound.

27. A two-coat plasterboard jointing system as claimed in claim 26, wherein the fibres are polymer-based fibres.

28. A two-coat plasterboard jointing system as claimed in claim 27, wherein the jointing compound includes polymer-based fibres in a proportion less than 1% by weight.

29. A method of jointing two plasterboard panels, including the steps of fixing one plasterboard panel relative to a second plasterboard panel such that an edge of the first panel faces an edge of the second panel to form a joint, applying to the joint a first coat of jointing compound, the jointing compound including a plaster component and a polymer component, and applying to the joint over the first coat a second coat of finishing compound.

30. A method of jointing two plasterboard panels as claimed in claim 29, wherein the jointing compound includes polymer-based fibres.

31. A plasterboard jointing compound including a plaster component and a polymer component, wherein the plaster component is in the form of calcium sulphate hemihydrate (plaster of Paris) at a proportion of greater than 80% by weight.

32. A plasterboard jointing compound as claimed in claim 31, wherein the polymer component is in the form of a polymer binder in a proportion of less than 5% by weight, and more preferably between 2 and 5%.

33. A plasterboard jointing compound as claimed in claim 31, wherein the jointing compound includes fibres within the jointing compound.

34. A plasterboard jointing compound as claimed in claim 33, wherein the fibres are polymer-based fibres.

35. A plasterboard jointing compound as claimed in claim 34, wherein the jointing compound includes polymer-based fibres in a proportion of less than 1% by weight.

36. A plasterboard jointing compound as claimed in claim 33, wherein the jointing compound includes the following components in the listed proportions by weight:

| | |
|---|---|
| Calcium Sulphate Hemihydrate | 80-95% |
| Mica | <7.5% |
| Talc | <7.5% |
| Polymer binder | 2-5% |
| Attapulgite Clay | <1% |
| Cellulose thickener | <0.5%. |

37. A plasterboard jointing compound as claimed in claim 36, wherein the jointing compound also includes the following component in the listed proportion by weight:

| | |
|---|---|
| Polymer fibre | <1%. |

38. A two-coat plasterboard jointing system substantially as hereinbefore described with reference to the accompanying drawings.

39. A method of jointing two plasterboard panels substantially as hereinbefore described with reference to the accompanying drawings.
